(19) United States
(12) Patent Application Publication
(10) Pub. No.: US 2015/0142684 A1
(43) Pub. Date: May 21, 2015

(54) Social Networking Software Application with Identify Verification, Minor Sponsorship, Photography Management, and Image Editing Features

(71) Applicant: Chong Y. Ng, Seattle, WA (US)

(72) Inventor: Chong Y. Ng, Seattle, WA (US)

(21) Appl. No.: 14/530,688

(22) Filed: Oct. 31, 2014

Related U.S. Application Data
(60) Provisional application No. 61/897,956, filed on Oct. 31, 2013.

(51) Int. Cl. G06K 9/00; G06Q 50/00; H04L 29/06

(52) U.S. Cl. CPC G06K 9/00221; H04L 63/08; G06Q 50/01
USPC 705/319; 726/3

(57) ABSTRACT

An social networking software application provides identify verification, minor sponsorship, photography management, and image editing features, in addition to providing efficient product and employment advertising. An event photography module enables the management and purchase of event photographs.

The current application claims a priority to the U.S. Provisional Patent application Ser. No. 61/897,956 filed on Oct. 31, 2013.

### FIELD OF THE INVENTION

The present invention relates generally to social media and event photography. More specifically, the present invention is a social media website with identity verification security, improved safety and security for minors, image content posting and editing, advertising, and event photography ordering.

### BACKGROUND OF THE INVENTION

The prevalence and popularity of social media has led to a correspondingly wide user base. As such, a common concern is the presence of impostors, scammers, and predators on social media platforms commonly used by minors. These users are capable of taking advantage of naïve and unaware minors under the shroud of anonymity. This is particularly problematic due to the lax security measures in place on many social media platforms. It is very often possible for an anonymous user to sign up for a social media user account with virtually no checks in place to ensure accountability of user actions. Additionally, unsavory users are able to create false identities in order to deceive inexperienced users as social media user accounts are virtually never tethered to a user's true identity. This makes it difficult for parents and guardians to monitor social media users with whom their children are interacting online.

The majority of social media platforms allow users to upload images that the user wishes to share publicly or privately. Because social media platforms generally do not provide image editing functionality, users must perform any image edit and alteration work independently prior to uploading and posting images. Images with people may often be tagged such that squares or similar shapes appear along with a person's name when a user places a mouse cursor over the person's face. Social media platforms typically incorporate a level of security in order to allow users to regulate those who may view and tag their uploaded images. However, users remain largely unregulated and as a result, virtually any user with access to a user's images may tag the images. While the tagging feature is very often innocent and useful, the previously discussed lack of identity verification creates opportunities for mischief. Behavior such as tagging faces multiple times and assigning/tagging offensive and inappropriate names leads to subsequent corruption of an image database.

Traditional product/service advertisements are often targeted towards a large consumer base. Similarly, job postings are targeted towards a large pool of job seekers. The lack of specific targeting towards a particular demographic creates difficulties for businesses and organizations when attempting to gauge the demand for a product/service and when screening job seekers based on qualifications. Hundreds to thousands of job seekers often submit applications to a single posting, overwhelming personnel who may not have the means to quickly screen applicants who are clearly unqualified for a position.

Event photography is often available for school dances, weddings, and other special occasions in order to provide attendees with high quality images of an event. Customers are generally provided two options for purchasing when attending an event, with each option bearing advantages and disadvantages. Photographers may provide event attendees with a prepaid envelope along with information regarding the photograph packages that the attendees may purchase. Payment is submitted prior to the photographs being taken. This is advantageous to photographers as prepaid sales are guaranteed and photographers do not provide service without payment. However, the photographers must physically handle payments as well as deal with issues such as matching customer names to images and interpreting poor handwriting on the order forms. Additionally, customers are unable to select favorite images nor customize or otherwise edit their images. In contrast to prepaid envelopes, photographers often offer online sales following an event. This is advantageous as photographers are not required to handle payments and large numbers of orders are quickly processed electronically. Additionally, customers are able to browse, select, and edit the images that they wish to purchase, increasing the likelihood of customers placing orders. The likelihood of shipping errors is decreased due to the electronic input of information. Orders are also automatically submitted to a photo lab for processing. However, online sales may be disadvantageous due to the lack of a guarantee of sales. Customers who do not like the taken images or forget to purchase prints result in lost sales. Although the average number of customer orders may increase, this increase in sales often does not cover the huge losses incurred due to non-purchasing customers.

The present invention seeks to address the aforementioned issues relating to social media and event photography. Furthermore, the present invention seeks to enhance and improve upon social media and event photography systems and methods currently in place.

The present invention is a social media website featuring identity verification security, improved safety and security for minors, image content posting and editing, advertising, and event photography ordering. In the preferred embodiment of the present invention, the website comprises two primary modules relating to social media and event photography ordering. The present invention incorporates improved security mechanisms designed to deter anonymous impostors, scammers, and predators. The present invention further incorporates means to increase the efficiency of businesses and organizations when posting advertisements for products/services and vacant employment positions. Finally, the present invention seeks to provide event photographers with a larger degree of control with regards to sales.

### BRIEF DESCRIPTION OF THE DRAWINGS

FIG. 1 is a diagram featuring major modules, features, and components of the social media website.

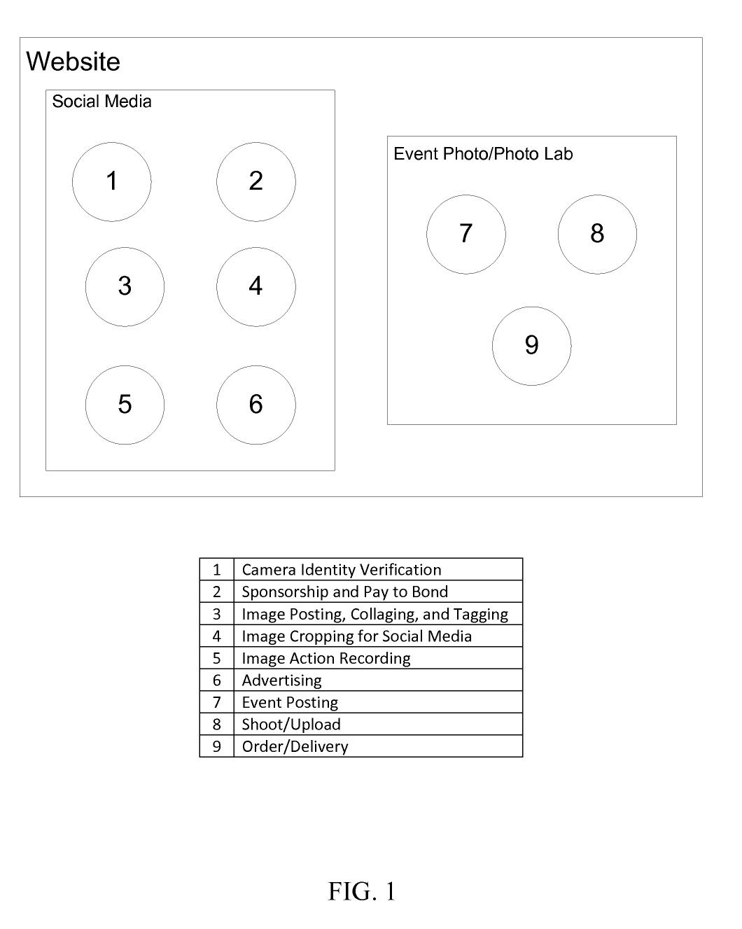

FIG. 2 is a flowchart depicting user actions in the identity verification module of the social media website.

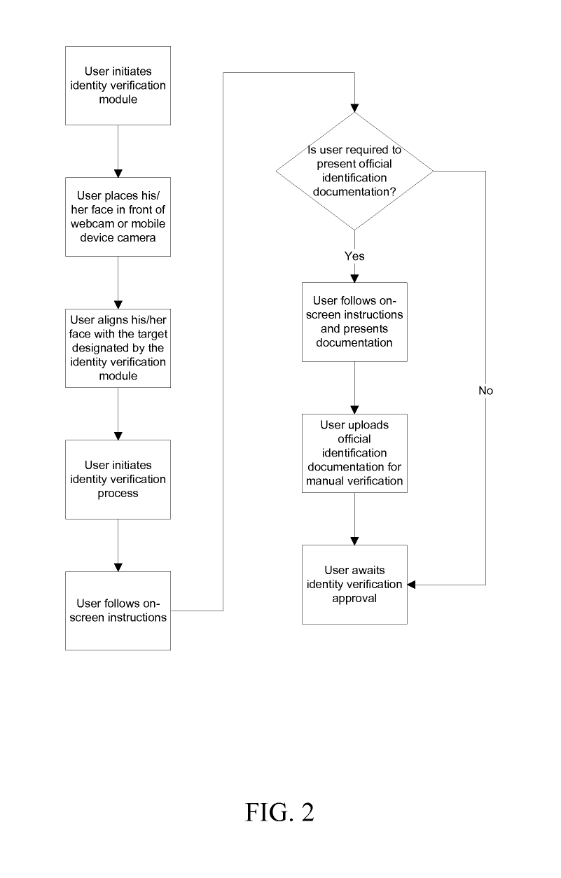

FIG. 3 is a flowchart depicting user actions in the sponsorship and bond fee payment procedures of the social media website.

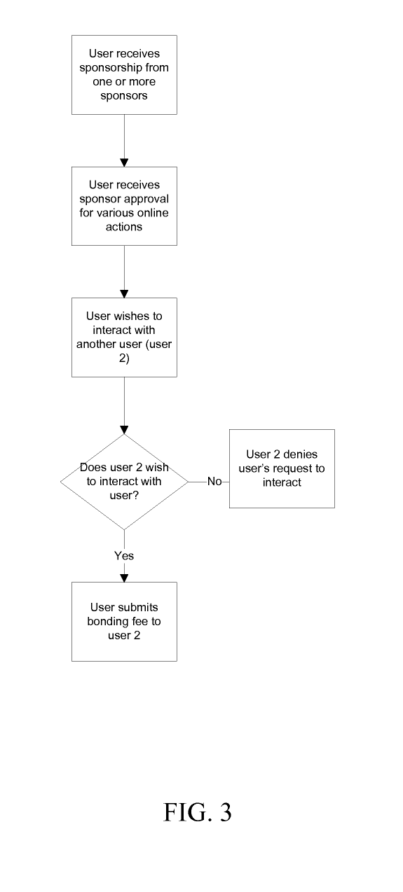

FIG. 4 is an example diagram of the image cropping feature of the social media website.

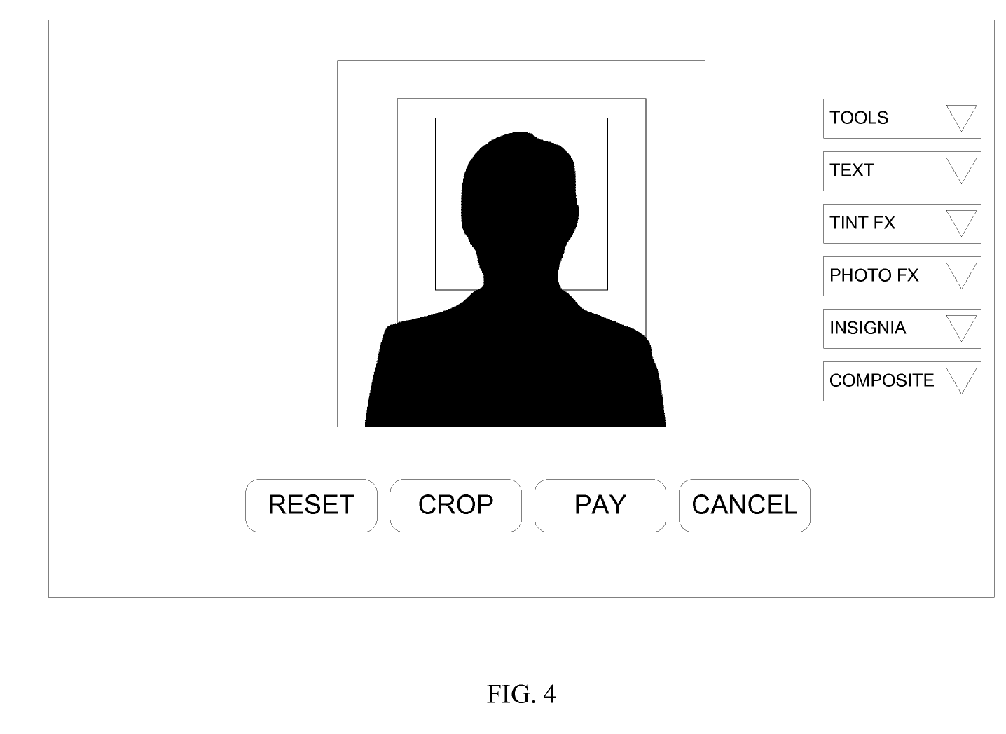

FIG. 5 is an example diagram of the image tagging and editing feature of the social media website.

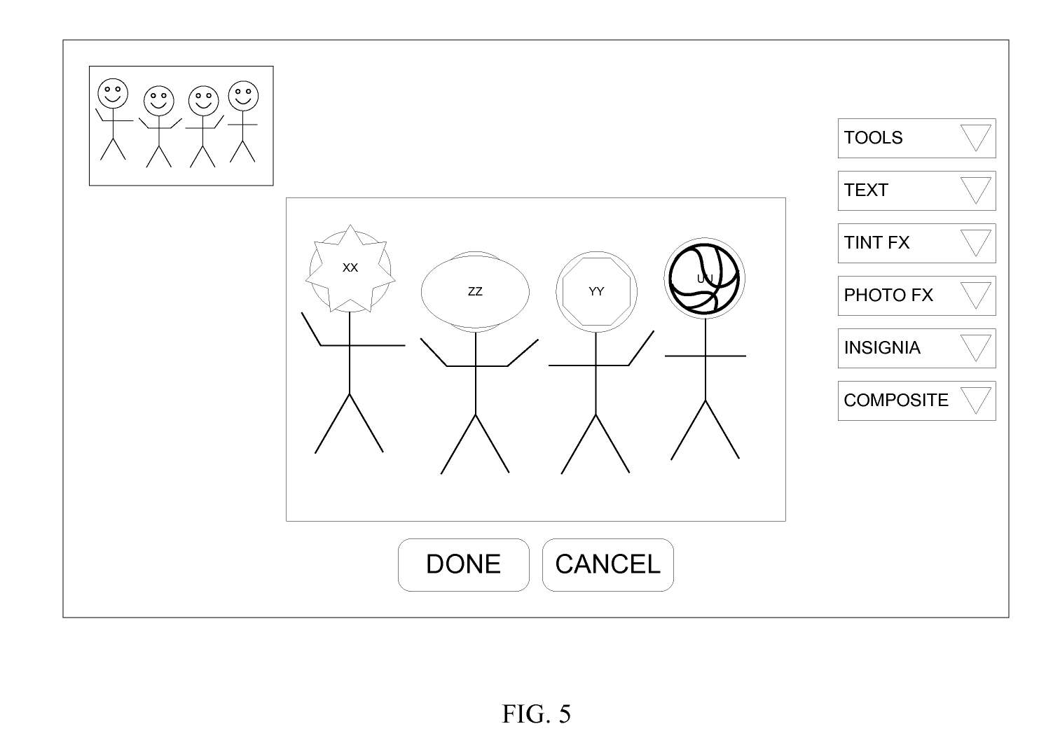

FIG. 6 is an example diagram of the image action recording feature of the social media website.

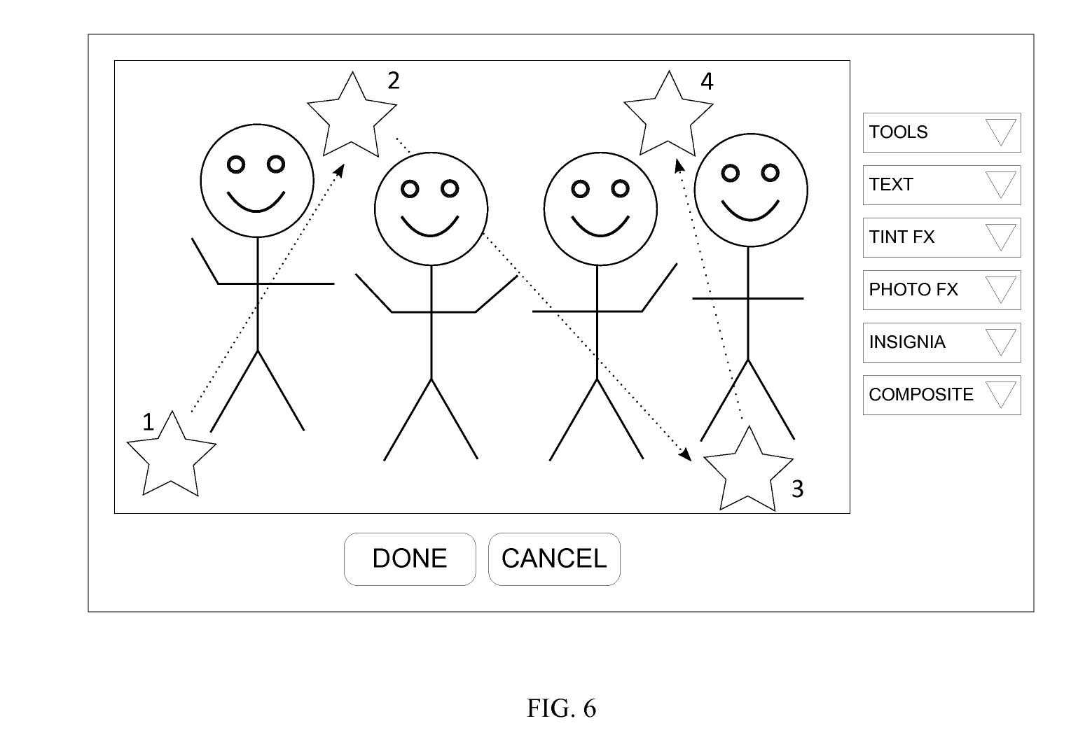

FIG. 7 is a flowchart depicting the event posting procedure of the social media website.

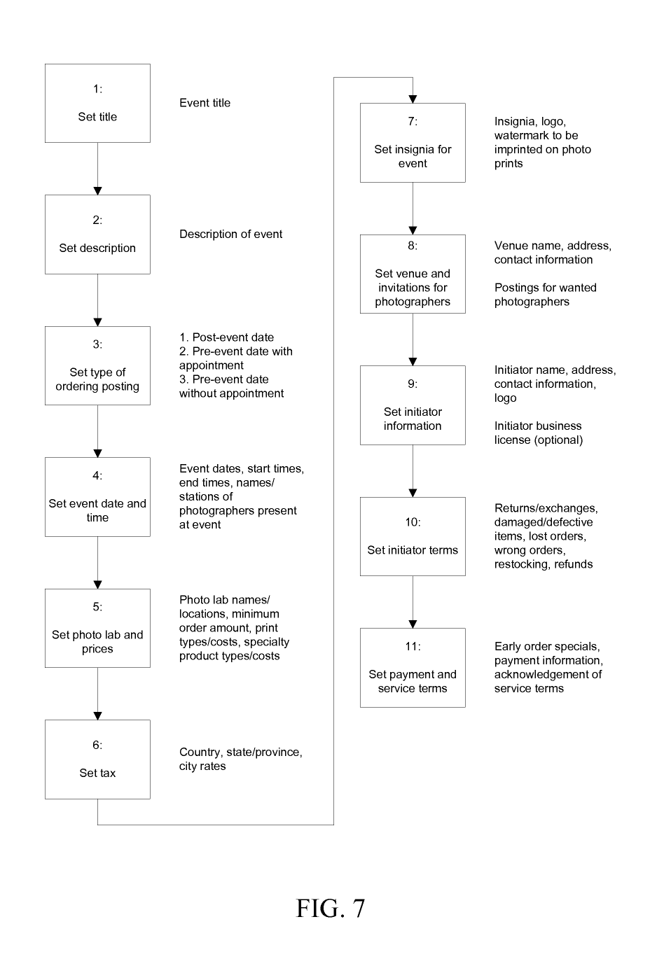

FIG. 8 is a flowchart depicting the customer event photography ordering process of the social media website.

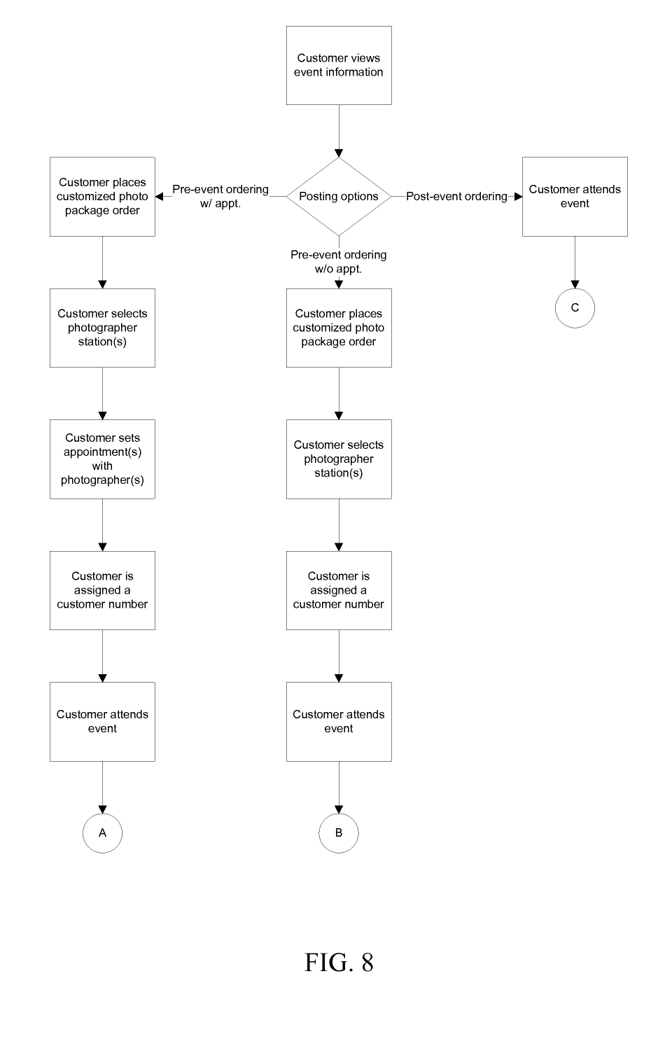

FIG. 9 is a flowchart depicting a continuation of the customer event photography ordering process of the social media website.

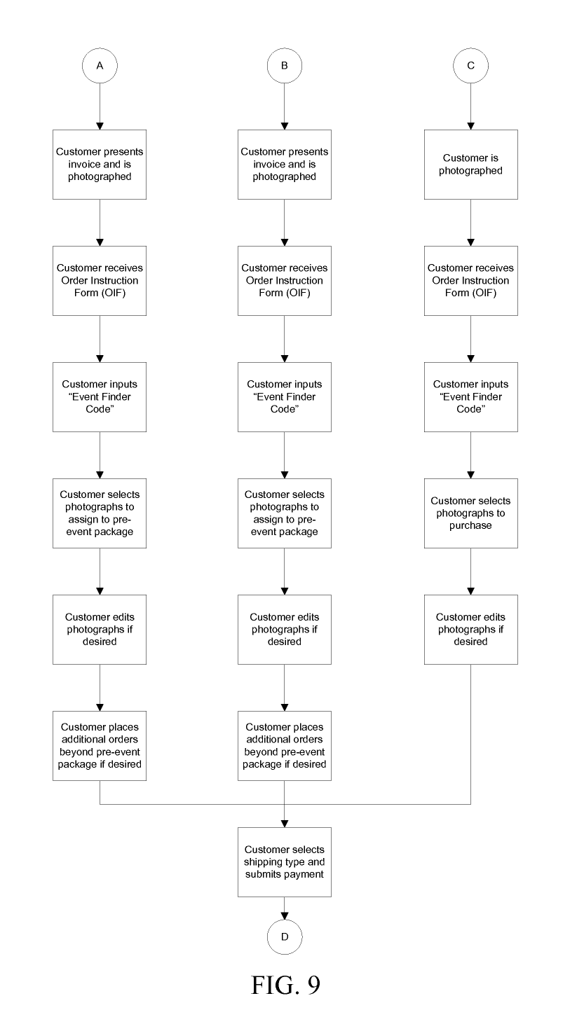

FIG. 10 is a flowchart depicting a continuation of the customer event photography ordering process of the social media website.

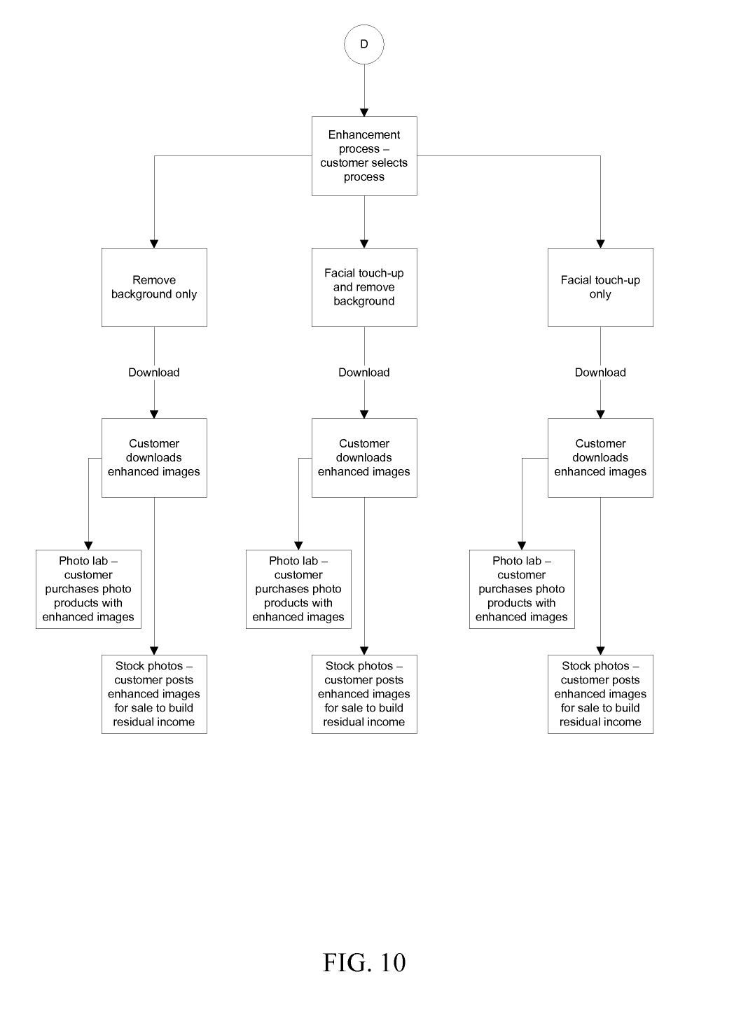

FIG. 11 is a flowchart describing the overall process of the present invention.

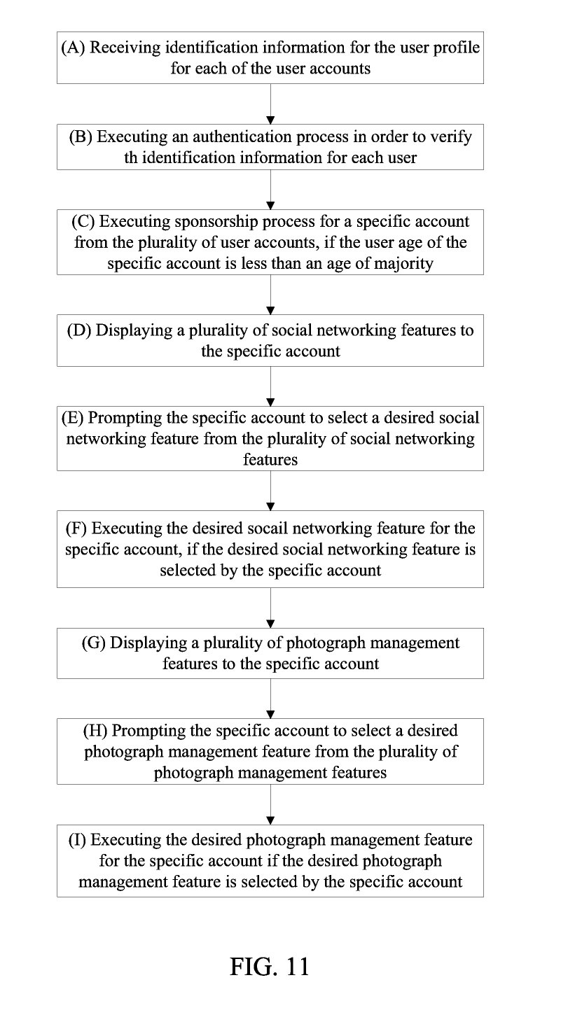

FIG. 12 is a flowchart describing the process for identify validation.

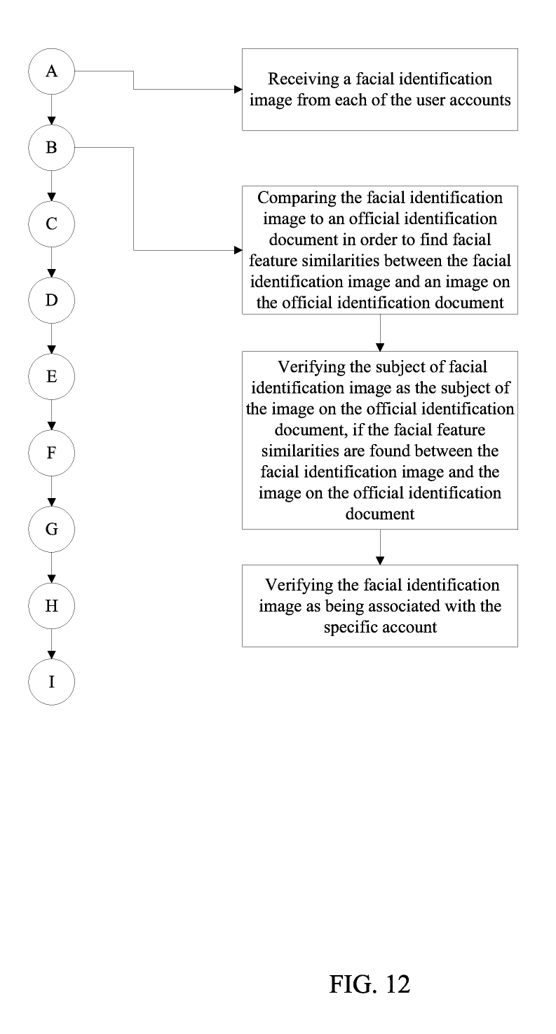

FIG. 13 is a flowchart describing the process for sponsorship of minors.

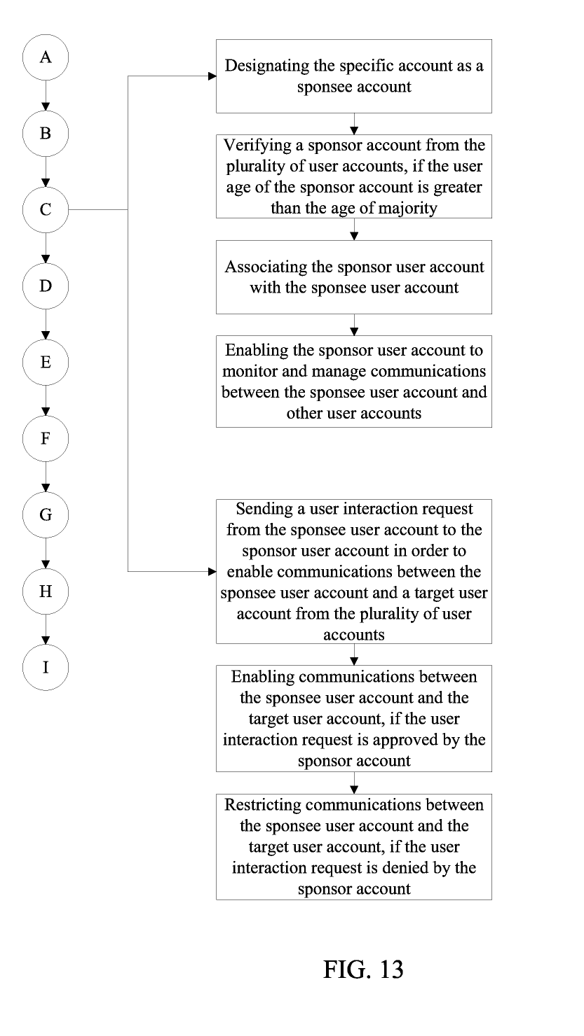

FIG. 14 is a flowchart describing the process for receiving misconduct violations.

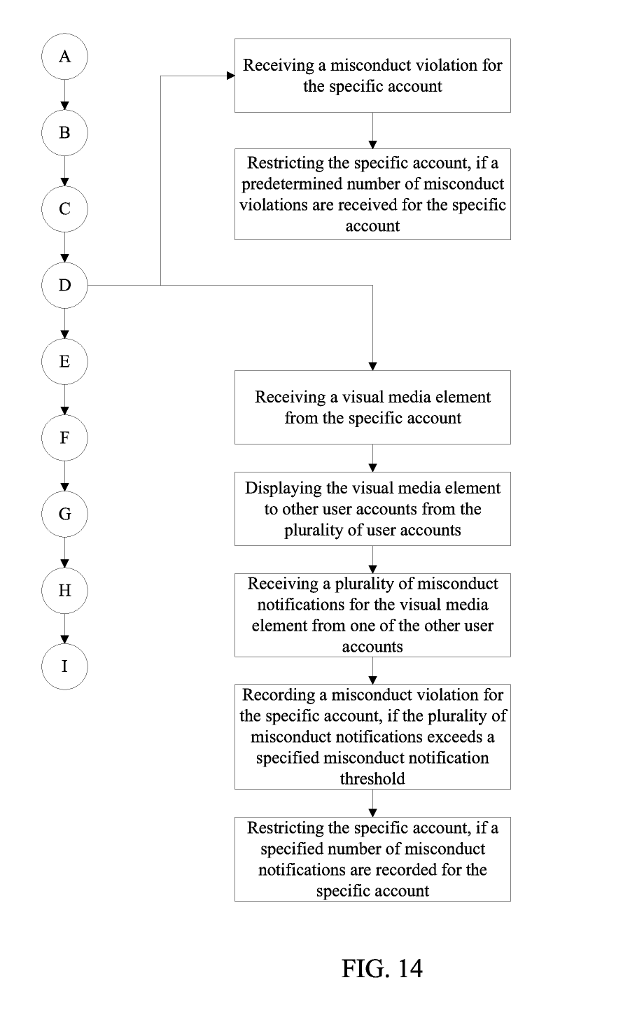

FIG. 15 is a flowchart describing the process for editing a digital image.

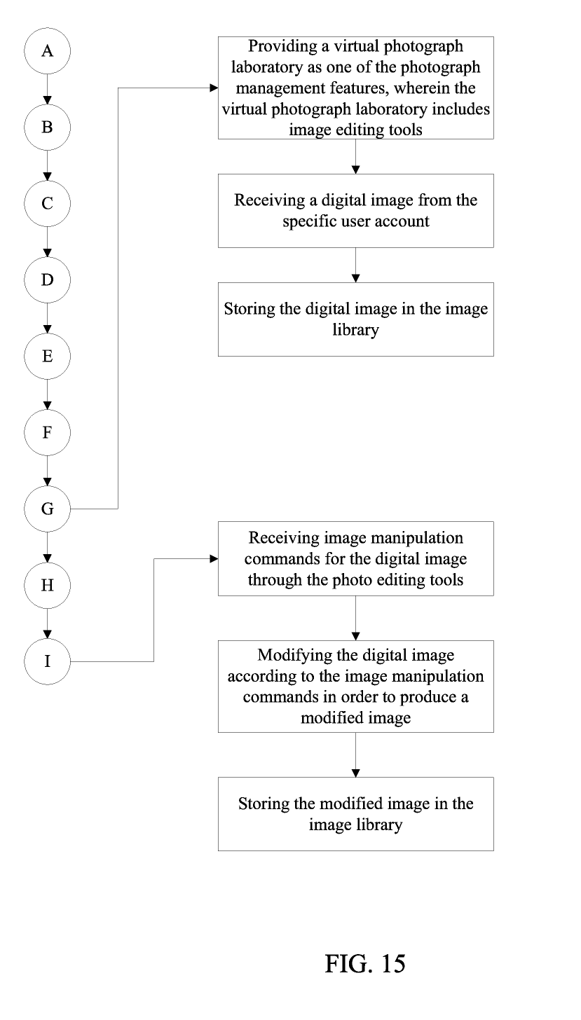

FIG. 16 is a flowchart describing the process for using the animation laboratory.

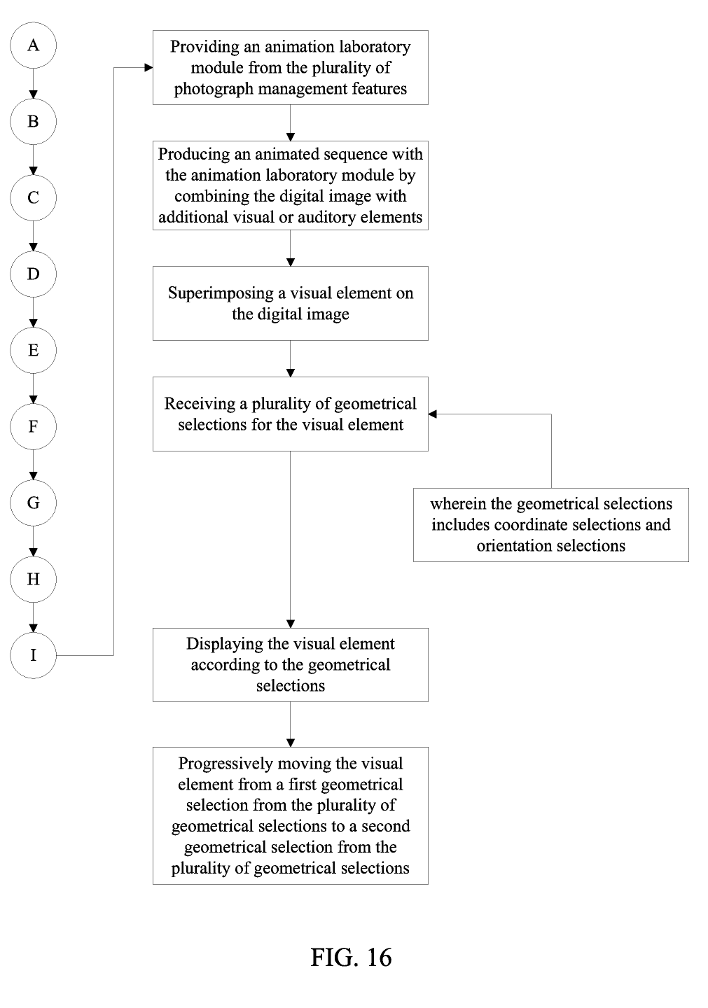

FIG. 17 is a flowchart describing the process for advertising products.

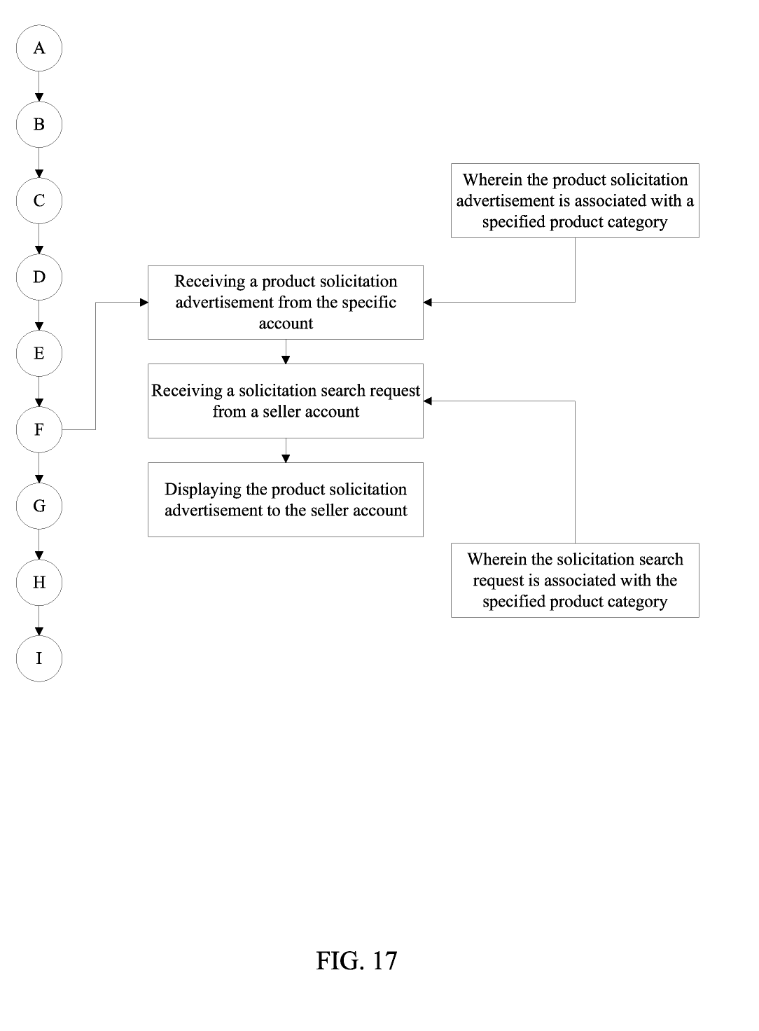

FIG. 18 is a flowchart describing the process for advertising employment.

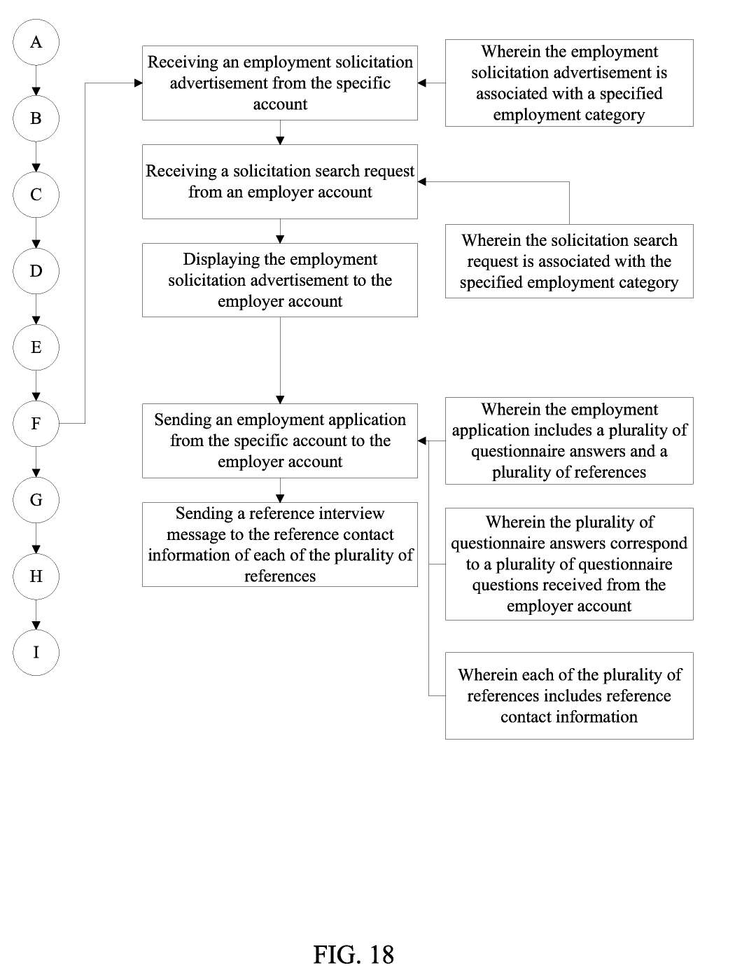

FIG. 19 is a flowchart describing the process for managing event photography.

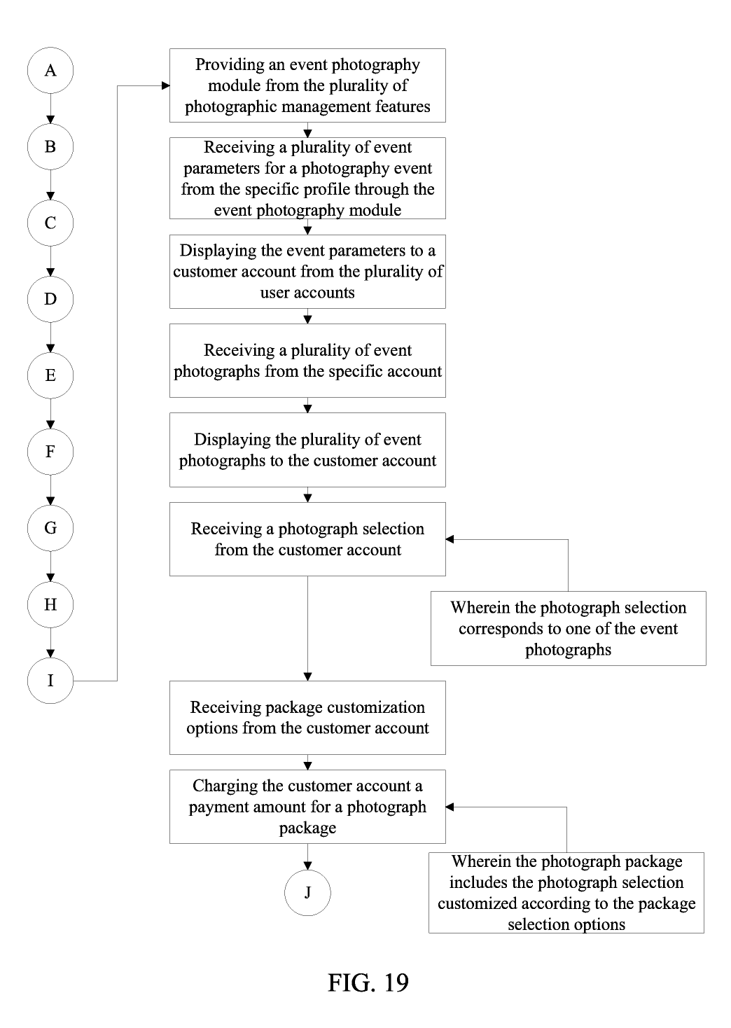

FIG. 20 is a flowchart describing additional processes for managing event photography.

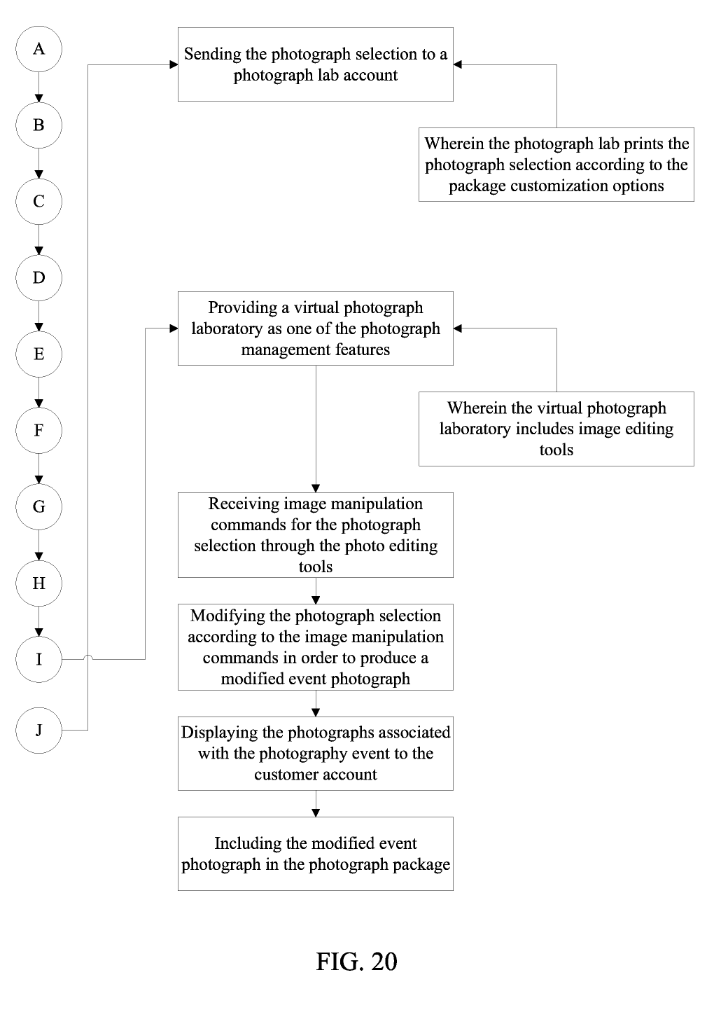

FIG. 21 is a flowchart describing the process for determining various pricing schemes for event photography.

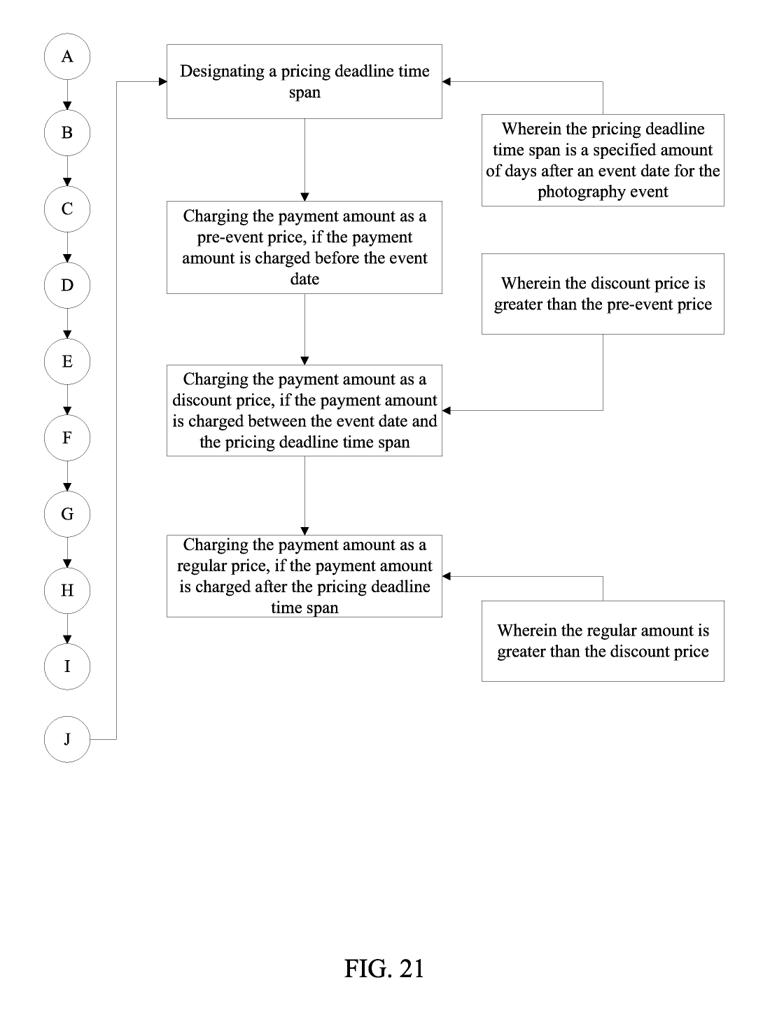

FIG. 22 is a flowchart describing the process for sending reminders to a customer to complete their order.

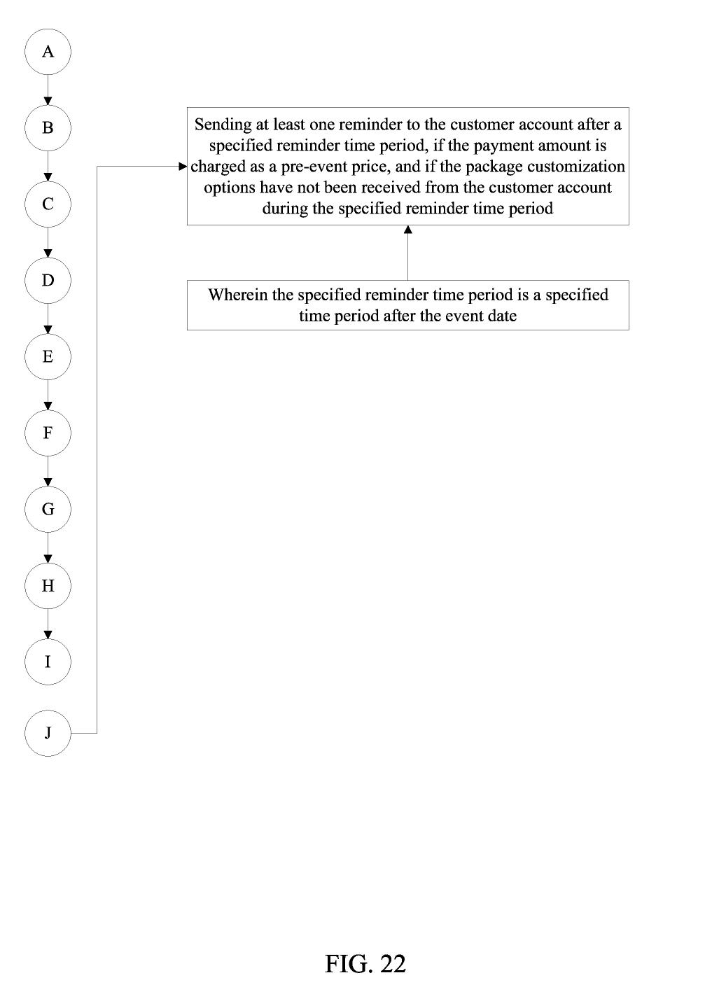

FIG. 23 is a flowchart describing the processes for setting up a photography appointment and using an event finder code.

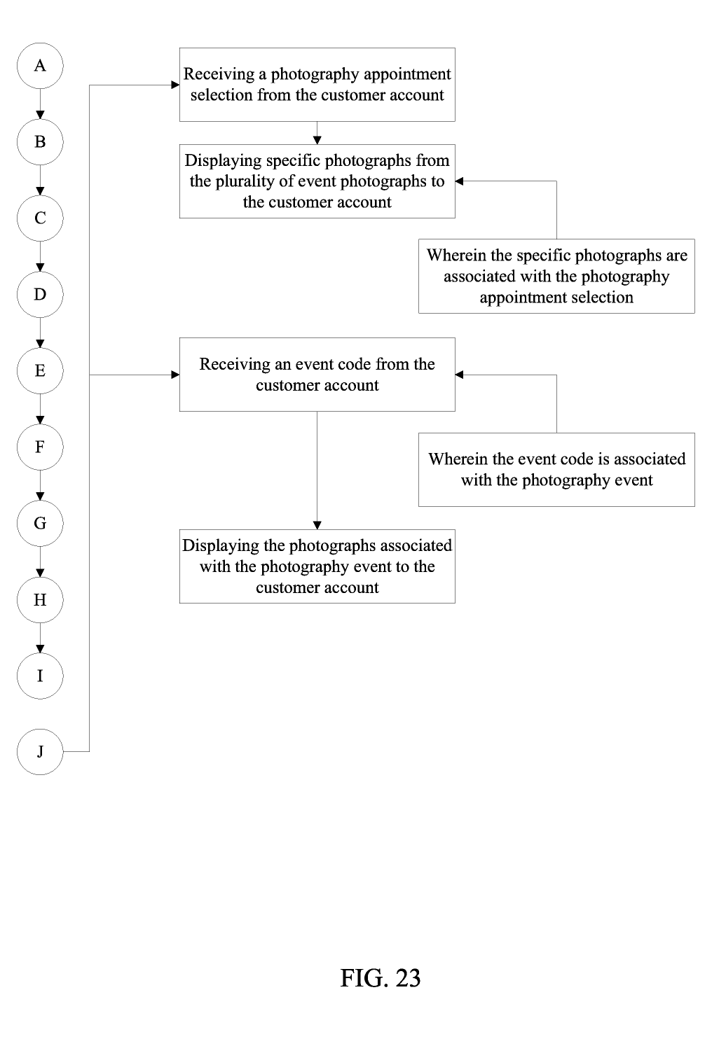

FIG. 24 is a flowchart describing the processes for a customer reselling a photograph.

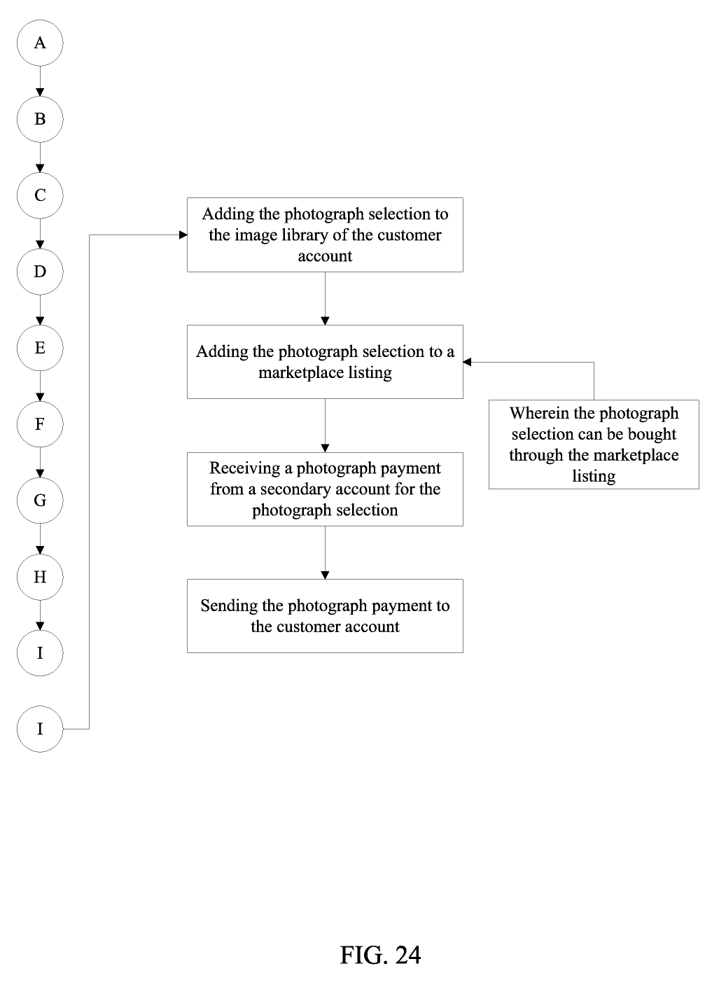

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a social networking software application for allowing multiple users to interact with each other over the internet. The present invention incorporates identity verification security, improved safety and security for minors, image content posting and editing, advertising, and event photography ordering. The preferred embodiment of the present invention has two primary components, a social networking module and an event photography module. The social media module comprises traditional social media features such as user account registration, user interactions and bonding, image uploading, tagging, and editing, and advertising for goods, services and employment. The event photography module comprises a system for streamlining the event photography ordering process as well as providing photographers with a larger degree of control with regards to sales.

The present invention provides users with the ability to sign up and create a user account, resulting in a plurality of user accounts being active through the present invention. Each of the plurality of user accounts includes a user profile and an image library, and the user profile includes a user age. In the preferred embodiment, each user accesses the present invention as a website through a user interface, which is any electronic device capable of connecting to the internet and displaying a web interface for the present invention, through which each of the user accounts utilizes the present invention. Each of the user accounts must be verified through the security measures of the present invention. To this end, identification information is received from the user profile for each of the user accounts, and an authentication process is executed in order to verify the identification information for each of the user accounts.

In the preferred embodiment of the present invention, the authentication process is as follows. A facial identification image is received from each of the user accounts. The facial identification image is compared to an official identification document in order to find facial feature similarities between the facial identification image and an image on the official identification document. The subject of the facial identification image is verified as the subject of the image on the official identification document if the facial feature similarities are found between the facial identification image and the image on the official identification document. The facial identification image for a specific account is then associated with the specific account. It should be noted that the “specific account” is used herein as a generic singular placeholder for any account from the plurality of user accounts.

More specifically, in the preferred embodiment of the present invention, a secondary verification process is executed to ensure that the specific account is being operated by a human as opposed to being operated by an automated process. To this end, a camera interface is displayed to the specific account, similar to a webcam feature. A continuous feed of images is received through the camera interface. A first facial identification image is captured, and subsequently an action prompt is displayed to the specific account, requesting that the user of the specific account perform a requested action. For example, the action prompt may request that the user smile, wave or perform another action. Subsequently, a second facial identification image is captured after displaying the action prompt. The purpose of this sequence is to ensure that the user operating the specific account is a person by evaluating the user's capability of interpreting said action request and performing said action. A plurality of additional facial identification images may be captured in addition to the first facial identification image and the second facial identification image.

One feature of the present invention promotes improved safety and security for underage users. If the user age of the specific account is less than an age of majority (18 years of age in the United States, for example) then a sponsorship process is executed for the specific account. Once the user age of the specific account is determined to be less than the age of majority, the specific account is designated as a sponsee account, or alternatively, a minor account. A sponsor account is then verified from the plurality of user accounts. The user age of the sponsor account must be greater than the age of majority. In many cases, the user operating the sponsor account is the parent or other guardian of the user operating the sponsee account. The sponsor user account is associated with the sponsee account, and the sponsor user account is enabled to manage and monirot communications between the sponsee user account and other accounts.

If the user operating the sponsee account desires to interact with another user account, a user interaction request is sent from the sponsee user account to the sponsor user account in order to enable communications between the sponsee user account and a target user account from the plurality of user accounts. The user operating the sponsor account makes a decision as to whether the sponsee user account is allowed to communicate with the target accounts. If the user interaction request is approved by the sponsor account, communications are enabled between the sponsee user account and the target user account. If the user interaction request is denied by the sponsor account, communications are restricted between the sponsee user account and the target user account. In one embodiment of the present invention, the sponsee user account is allowed to communicate with other sponsee accounts without requiring an approved user interaction request. In another embodiment, the sponsee user account must submit a user interaction request in order to communicate with any other account from the plurality of user accounts. In other embodiments, various other conditions may apply for enabling or restricting communications between the sponsee account and other accounts. Additionally, various degrees of communication may be allowed or restricted between the sponsee account and other accounts. For example, communication may be limited to text conversations, or text conversations may be limited to a specified time frame, character count or message count. Other forms of communication may be allowed, restricted or otherwise managed, such as, but not limited to, sending of images, audio files, or video files.

Accounts may engage in typical social networking activities. To this end, a plurality of social networking features is displayed to the specific account. Said social networking features may include, but are not limited to, connecting with other accounts, sending messages directly to other accounts, sending messages indirectly to other accounts in the form of postings to a community bulletin board, activity feed or similar venus, in the form of text, image, video, audio, or other formats or materials. Other social networking features may comprise creating and joining event postings, groups, calendars, lists, playing browser games, or other such features. Some features may be displayed to the specific account at all times, and other features may require the specific account to navigate through menus, require additional input such as passwords to access, or other actions may be required.

The specific account is prompted to select a desired social networking feature from the plurality of social networking features. If the desired account then selects the desired social networking feature, the desired social networking feature is executed.

In addition to the social networking features, a plurality of photograph management features are displayed to the specific account, and the specific account is prompted to select a desired photograph management feature from the plurality of photograph management features. If the desired photograph management feature is selected by the specific account, the desired photograph management feature is executed for the specific account. It should be noted that the plurality of photograph management features may not be displayed to the specific account at all times, and may require navigation through menus or other features in order to access.

One feature of the present invention is a self-policing content policy. If the specific account uploads or posts objectionable material, other user accounts from the plurality of user accounts may “flag” the objectionable material. If another account from the plurality of accounts flags the objectionable material, a misconduct notification is received for the specific account. If a predetermined number of misconduct notifications are received for the specific account, the specific account is then restricted.

The objectionable material is received from the specific account in the form of a media element. In the preferred embodiment of the present invention, the focus of the self-policing content policy is for images. However, the media element may comprise text, visual, or auditory material, or any other material that may be found objectionable. The media element is received from the specific account, and subsequently displayed to other user accounts from the plurality of user accounts. One of the other user accounts from the other user accounts may then flag the media element as objectionable, which results in a misconduct notification being received for the media element from the one of the other user accounts. Misconduct notifications may accumulate from a plurality of user accounts. If a plurality of misconduct notifications accumulates for the media element, and exceed a specified misconduct notification threshold, a misconduct violation is recorded for the specific account. The difference between misconduct notifications and misconduct violations is that a single misconduct notification is an indication from a single user account that the media element is objectionable, while a misconduct violation occurs when a specified number of misconduct notifications is received for the media element. In the preferred embodiment of the present invention, 100 misconduct notifications are required to receive one misconduct violation. Additionally, in the preferred embodiment, three misconduct violations must be received for the specific account in order to restrict the specific account. Other thresholds for receiving a misconduct violation or for restricting the specific account may be implemented. Restrictions for the specific account may vary, and may be determined by an administrator of the website.

The present invention also comprises a virtual photograph laboratory as one of the photograph management features, wherein the virtual photograph laboratory includes image editing tools. User accounts may upload and edit images using the virtual photograph laboratory. When a digital image may received from the specific user account, the digital image is stored in the image library. Subsequently, the specific account may utilize the image editing tools to edit the digital image. Image manipulation commands are received for the digital image through the photo editing tools. The digital image is then modified according to the image manipulation commands to produce a modified image, and the modified image is then stored in the image library. The image manipulation commands may comprise any number of relevant image manipulation functions, such as, but not limited to, cropping, drawing in any desired color, adjusting attributes such as saturation, brightness, contrast, or hue, or adding elements such as objects or text. The modified image is available for download in various file formats.

The present invention additionally comprises an animation laboratory module from the plurality of photograph management features, which may be used to produce an animated sequence by combining the digital image with additional visual or auditory elements. The animation laboratory module may be utilized to produce products such as virtual greeting cards that can be sent to other user accounts, and/or downloaded in various file formats, preferably in a video format such as a .mp4 or .mpg file. The animation laboratory module may also be referred to as an image action recording module.

To utilize the animation laboratory module, a visual element is superimposed on the digital image. A plurality of geometrical selections are received for the visual element, wherein the geometrical selections include coordinate selections and orientation selections. In other words, the user selects coordinates and orientation for the visual element. The visual element is then displayed according to the geometrical selections. For an animation, a first geometrical selection and a second geometrical selection from the plurality of geometrical selections are received from the specific account, and the visual element is progressively moved from the first geometrical selection to the second geometrical selection.

Another feature comprised in the present invention is an efficient advertising service for products and employment. A product solicitation advertisement is received from the specific account, wherein the product solicitation advertisement is associated with a specific product category that the operator of the specific account is looking to purchase. Many different accounts may submit such product solicitation advertisements, creating a marketplace. The product solicitation request may be comprise a number of details, such as, but not limited to, a specific product and a time frame in which the user wishes to buy the product. For example, a user may be looking to buy the product on the same day the user submits the product solicitation advertisement, or the user may be looking to buy the product within a month of submitting the product solicitation advertisement.

A seller account from the plurality of accounts may then search the marketplace to ascertain demand and to locate buyers. A solicitation search request is then received from the seller account, wherein the solicitation search request is associated with the specified product category. The solicitation search request may comprise similar details to the product solicitation request, such as, but not limited to, a specific product of type of product and a time frame users are looking to buy the product within. Users may specify that they are looking to buy now, buy soon, or buy later, for example. The product solicitation advertisement from the specific account is then displayed to the seller account, along with any other solicitation advertisements from other user accounts that match the parameters of the solicitation advertisement. The seller account may then contact the specific account in order to sell the product solicited by the user. In the preferred embodiment of the present invention, the seller account pays a specified fee to contact each user account, such as, but not limited to, one dollar per user account. Also in the preferred embodiment, the seller account is required to offer a coupon or discount to the specific account in order to sell the product, such as, but not limited to, ten percent of the product's retail value. Other seller accounts may compete with each other to gain the specific account's business by offering better coupons or discounts. Additionally, each coupon send to user accounts has a unique identification number for tracking purposes. When a user account redeems the coupon, the coupon is marked as used. In this way, the seller may track their return on investment by utilizing the advertising functionality of the present invention.

A similar feature is provided by the present invention for employment seekers and employers. In this case, the employment seekers are analogous to the buyers from the product advertising service, and the employers are analogous to the sellers from the product advertising service. More specifically, an employment solicitation advertisement is received from the specific account, wherein the employment solicitation advertisement is associated with a specific employment category. A solicitation search request is received from an employer account, wherein the solicitation search request is also associated with the specified product category. The solicitation search request aims to discover matching employment solicitation requests. The employment solicitation advertisement is then displayed to the employer account, and the employer account may contact the specific account. Similarly to the product advertisement service, in the preferred embodiment of the present invention, the employment account is charged a fee in order to contact the specific account with an employment opportunity. This functions to deter spam and junk mail.

In the preferred embodiment, when contacting the user of the specific account the employer requests that the user provides answers to a questionnaire and a plurality of references, wherein each of the plurality of references includes reference contact information. An employment application is then sent from the specific account to the employer account, wherein the employment application includes a plurality of questionnaire answers and a plurality of references, and wherein the plurality of references correspond to past employers of the user. The plurality of questionnaire answers corresponds to a plurality of questionnaire questions received by the specific account from the employer account. In the preferred embodiment, a reference interview message is automatically sent to the reference contact information of each of the plurality of references. In the preferred embodiment, the reference interview message includes, but is not limited to, a question as to whether the user operating the specific account is recognized by the reference, and a question as to whether the reference would hire the user again. Additionally, the questionnaire answers are preferably graded automatically according to a predetermined grading scheme created by the employer.

The second primary module of the present invention is an event photography module that is one of the plurality of photographic management features of the present invention. The event photography module is designed to be an efficient means for a photographer or other event organizer to benefit from selling photographs taken at an event, such as, but not limited to, a wedding, a school dance, or another event.

In this scenario, the specific account is operated by the organizer of a photography event. The organizer may be an individual photographer running a photography business, or the organizer may be operated by one or more school officials, in the case of a school dance or student identification event, or the organizer may be of a different nature depending on the nature of the event.

A plurality of event parameters are received for the photography event are received through the event photography module. The event parameters may include, but are not limited to, event title, event description, date of the event, start time and end time of the event, names and locations of various photographer stations, tax rates, insignia, logo, or watermark, venue name, address, and contact information, event initiator information, policies for returns, exchanges, defective items, lost or wrong orders, restocking, and refunds, and details about early order specials, payment information, and acknowledgement of service terms. The event parameters are displayed to a customer account from the plurality of user accounts.

The event takes place, and a plurality of event photographs are taken by one or more photographers. The plurality of event photographs is then uploaded and received from the specific account, and then displayed to the customer account. A photograph selection is then received from the customer account, wherein the photograph selection corresponds to one of the event photographs. Package customization options are received from the customer account. The package customization options refer to options for purchasing physical prints of the photograph selection. The customer account is offered a variety of customization options, including, but not limited to, print dimensions, print medium, and photo editing options. The customer may order multiple photos and/or multiple packages. For example, the customer may order a 5×7 print of photo A, two 8×10 prints of photo B, a print of photo C on a mousepad, and a print of photo D on a decorative ornament. Each photo and product ordered carries its own price, and a subtotal for the order must be calculated according to the various product prices and any licensing fees and taxes that apply. The customer account is then charged a payment amount for a photograph package, wherein the photograph package includes the photograph selection customized according to the package customization options. The photograph selection (or the photograph package, whichever is applicable) is then sent to a photograph lab account, which proceeds to print the photograph selection according to the package customization options.

The event photography module may also make use of the virtual photograph laboratory previously described. Package customization options selected by the customer account may include image manipulation commands that are received for the photograph selection through the photo editing tools. The photograph selection is modified according to the image manipulation commands in order to produce a modified event photograph, and the modified event photograph is included in the photograph package. Additionally or alternately, the modified event photograph may be stored in the image library of the customer account.

In the preferred embodiment of the present invention, several options are available to the customer or the organizer for purchasing or selling photographs. The first option is pre-event ordering. In this case, the customer account submits package customization options without knowing what photograph is going to be used in the photograph package. In this case, the customer account is charged the payment amount as a pre-event price, since the payment amount is charged before the event date. In the preferred embodiment, the pre-event price is the cheapest price. The pre-event ordering is intended to increase photograph sales by guaranteeing a sale. Additionally, the low price is attractive to customers. After the event occurs, the customer views the plurality of event photographs and makes the photograph selection. The photograph selection is then combined with the package customization options and sent to the photography lab.

An additional option available for pre-event ordering is making an appointment for photographs to be taken at the event. In this case, a photography appointment selection is received from the customer account. After the event, in order to make the photograph selection, specific photographs are displayed from the plurality of event photographs to the customer account, wherein the specific photographs are associated with the photography appointment selection. In the preferred embodiment, any valid means for correlating the specific photographs with the photography appointment selection may be utilized.

The last option for purchasing event photographs is post-event ordering. In this case, the customer does not commit to purchasing prints until after the event is over. This option is not necessarily a very efficient means for producing sales, since the customer may decide that they do not like any of the event photographs, or do not mind having a watermark on their photographs, and therefore decide not to make any purchases. With post-event ordering, a pricing deadline time span is designated, wherein the pricing deadline time span is a specified amount of days after the event date. If the customer purchases prints between the event date and the pricing deadline time span, the payment amount is charged at a discount price. Preferably, the discount price is greater than the pre-event price. Preferably, the pricing deadline time span is 15 days after the event date. After the pricing deadline time span, if a customer chooses to make an order, the payment amount is charged as a regular price, which is greater than the discount price. The pricing deadline time span functions as incentive for customers to actually make a purchase due to the better price.

For customers participating in pre-event ordering, reminders are sent to the customer account after a specified reminder time period, if the payment amount is not charged during the specified reminder time period, wherein the specified reminder time period is a specified time period after the event date. Preferably, multiple reminders are sent to the customer account, including a final reminder on the final day of the specified reminder time period. If the customer does not complete their order within the specified reminder time period, the order expires and the customer's money is forfeit.

An additional feature for the present event is providing an event finder code to customers. The event finder code helps customers to directly locate relevant photos from the event, as opposed to having to search through multiple photo galleries of other events to find the relevant photos. The event code is received from the customer account, wherein the event code is associated with the photography event. The event photographs associated with the photography event are then displayed to the customer account, and the purchasing process proceeds as normal. This feature aids in security of the event photographs, since individuals without an event finder code should not be able to access the event photographs as they might be exploited toward undesirable ends.

Additionally, the present invention provides the customer account with the option to resell the photograph selection, in the case that the photograph selection is originally available for purchase as a digital file. The photograph selection is purchased by the customer account and added to the library of the customer account. Subsequently, the customer account adds the photograph selection to a marketplace listing, wherein the photograph selection can be purchased by other accounts through the marketplace listing. If a secondary account wishes to purchase the photograph selection, a photograph payment is received from the secondary account and subsequently sent to the customer account.

Although the invention has been explained in relation to its preferred embodiment, it is to be understood that many other possible modifications and variations can be made without departing from the spirit and scope of the invention as hereinafter claimed.

What is claimed is:

1. A social networking software application with identify verification, minor sponsorship, photography management, and image editing features comprises the steps of:
providing a plurality of user accounts,
wherein each of the plurality of user accounts includes a user profile and an image library;
wherein the user profile includes a user age;
receiving identification information for the user profile for each of the user accounts;
executing an authentication process in order to verify the identification information for each of the user accounts;
executing a sponsorship process for a specific account from the plurality of user accounts,
if the user age of the specific account is less than an age of majority;
displaying a plurality of social networking features to the specific account;
prompting the specific account to select a desired social networking feature from the plurality of social networking features;
executing the desired social networking feature for the specific account,
if the desired social networking feature is selected by the specific account;
displaying a plurality of photograph management features to the specific account;
prompting the specific account to select a desired photograph management feature from the plurality of photograph management features; and
executing the desired photograph management feature for the specific account,
if the desired photograph management feature is selected by the specific account.

2. A social networking software application with identify verification, minor sponsorship, photography management, and image editing features as claimed in claim 1 comprises the steps of:
receiving a facial identification image from each of the user accounts;
comparing the facial identification image to an official identification document in order to find facial feature similarities between the facial identification image and an image on the official identification document;
verifying the subject of facial identification image as the subject of the image on the official identification document,
if the facial feature similarities are found between the facial identification image and the image on the official identification document; and
verifying the facial identification image as being associated with the specific account.

3. A social networking software application with identify verification, minor sponsorship, photography management, and image editing features as claimed in claim 2 comprises the steps of:
capturing a first facial identification image;
displaying an action prompt to the specific account to perform a requested action; and
capturing a second facial identification image after displaying the action prompt.

4. A social networking software application with identify verification, minor sponsorship, photography management, and image editing features as claimed in claim 1 comprises the steps of:
designating the specific account as a sponsee account;
verifying a sponsor account from the plurality of user accounts,
if the user age of the sponsor account is greater than the age of majority;
associating the sponsor user account with the sponsee user account; and
enabling the sponsor user account to monitor and manage communications between the sponsee user account and other user accounts.

5. A social networking software application with identify verification, minor sponsorship, photography management, and image editing features as claimed in claim 4 comprises the steps of:
sending a user interaction request from the sponsee user account to the sponsor user account in order to enable communications between the sponsee user account and a target user account from the plurality of user accounts;
enabling communications between the sponsee user account and the target user account,
if the user interaction request is approved by the sponsor account; and
restricting communications between the sponsee user account and the target user account,
if the user interaction request is denied by the sponsor account.

6. A social networking software application with identify verification, minor sponsorship, photography management, and image editing features as claimed in claim 1 comprises the steps of:
receiving a misconduct violation for the specific account; and
restricting the specific account, if a predetermined number of misconduct violations are received for the specific account.

7. A social networking software application with identify verification, minor sponsorship, photography management, and image editing features as claimed in claim 1 comprises the steps of:
receiving a media element from the specific account;
displaying the media element to other user accounts from the plurality of user accounts;
receiving a misconduct notifications for the media element from one of the other user accounts;
recording a misconduct violation for the specific account, if the plurality of misconduct notifications exceeds a specified misconduct notification threshold; and
restricting the specific account, if a specified number of misconduct notifications are recorded for the specific account.

8. A social networking software application with identify verification, minor sponsorship, photography management, and image editing features as claimed in claim 1 comprises the steps of:
providing a virtual photograph laboratory as one of the photograph management features, wherein the virtual photograph laboratory includes image editing tools;
receiving a digital image from the specific user account; and
storing the digital image in the image library.

9. A social networking software application with identify verification, minor sponsorship, photography management, and image editing features as claimed in claim 8 comprises the steps of:
receiving image manipulation commands for the digital image through the photo editing tools;
modifying the digital image according to the image manipulation commands in order to produce a modified image; and
storing the modified image in the image library.

10. A social networking software application with identify verification, minor sponsorship, photography management, and image editing features as claimed in claim 8 comprises the steps of:
providing an animation laboratory module from the plurality of photograph management features; and
producing an animated sequence with the animation laboratory module by combining the digital image with additional visual or auditory elements.

11. A social networking software application with identify verification, minor sponsorship, photography management, and image editing features as claimed in claim 10 comprises the steps of:
superimposing a visual element on the digital image;
receiving a plurality of geometrical selections for the visual element, wherein the geometrical selections includes coordinate selections and orientation selections; and
displaying the visual element according to the geometrical selections.

12. A social networking software application with identify verification, minor sponsorship, photography management, and image editing features as claimed in claim 11 comprises the steps of:
progressively moving the visual element from a first geometrical selection from the plurality of geometrical selections to a second geometrical selection from the plurality of geometrical selections;

13. A social networking software application with identify verification, minor sponsorship, photography management, and image editing features as claimed in claim 1 comprises the steps of:
receiving a product solicitation advertisement from the specific account, wherein the product solicitation advertisement is associated with a specified product category;
receiving a solicitation search request from a seller account, wherein the solicitation search request is associated with the specified product category; and
displaying the product solicitation advertisement to the seller account.

14. A social networking software application with identify verification, minor sponsorship, photography management, and image editing features as claimed in claim 1 comprises the steps of:
receiving an employment solicitation advertisement from the specific account, wherein the employment solicitation advertisement is associated with a specified employment category;
receiving a solicitation search request from an employer account, wherein the solicitation search request is associated with the specified employment category; and
displaying the employment solicitation advertisement to the employer account.

15. A social networking software application with identify verification, minor sponsorship, photography management, and image editing features as claimed in claim 14 comprises the steps of:
sending an employment application from the specific account to the employer account,
wherein the employment application includes a plurality of questionnaire answers and a plurality of references;
wherein the plurality of questionnaire answers correspond to a plurality of questionnaire questions received from the employer account;
wherein each of the plurality of references includes reference contact information; and
sending a reference interview message to the reference contact information of each of the plurality of references.

16. A social networking software application with identify verification, minor sponsorship, photography management, and image editing features as claimed in claim 1 comprises the steps of:
providing an event photography module from the plurality of photographic management features;
receiving a plurality of event parameters for a photography event from the specific profile through the event photography module;
displaying the event parameters to a customer account from the plurality of user accounts;
receiving a plurality of event photographs from the specific account;
displaying the plurality of event photographs to the customer account;
receiving a photograph selection from the customer account, wherein the photograph selection corresponds to one of the event photographs;
receiving package customization options from the customer account; and
charging the customer account a payment amount for a photograph package, wherein the photograph package includes the photograph selection customized according to the package selection options.

17. A social networking software application with identify verification, minor sponsorship, photography management, and image editing features as claimed in claim 16 comprises the step of:
sending the photograph selection to a photograph lab account, wherein the photograph lab prints the photograph selection according to the package customization options.

18. A social networking software application with identify verification, minor sponsorship, photography management, and image editing features as claimed in claim 16 comprises the steps of:
providing a virtual photograph laboratory as one of the photograph management features, wherein the virtual photograph laboratory includes image editing tools;
receiving image manipulation commands for the photograph selection through the photo editing tools;
modifying the photograph selection according to the image manipulation commands in order to produce a modified event photograph; and
including the modified event photograph in the photograph package.

19. A social networking software application with identify verification, minor sponsorship, photography management, and image editing features as claimed in claim 16 comprises the steps of:
designating a pricing deadline time span, wherein the pricing deadline time span is a specified amount of days after an event date for the photography event;
charging the payment amount as a pre-event price, if the payment amount is charged before the event date;
charging the payment amount as a discount price, if the payment amount is charged between the event date and the pricing deadline time span, wherein the discount price is greater than the pre-event price; and
charging the payment amount as a regular price, if the payment amount is charged after the pricing deadline time span, wherein the regular amount is greater than the discount price.

20. A social networking software application with identify verification, minor sponsorship, photography management, and image editing features as claimed in claim 16 comprises the step of:
sending at least one reminder to the customer account after a specified reminder time period,
if the payment amount is charged as a pre-event price,
and if the package customization options have not been received from the customer account during the specified reminder time period;
wherein the specified reminder time period is a specified time period after the event date.

21. A social networking software application with identify verification, minor sponsorship, photography management, and image editing features as claimed in claim 16 comprises the steps of:
receiving a photography appointment selection from the customer account; and
displaying specific photographs from the plurality of event photographs to the customer account, wherein the specific photographs are associated with the photography appointment selection.

22. A social networking software application with identify verification, minor sponsorship, photography management, and image editing features as claimed in claim 16 comprises the steps of:
receiving an event code from the customer account, wherein the event code is associated with the photography event; and
displaying the photographs associated with the photography event to the customer account.

23. A social networking software application with identify verification, minor sponsorship, photography management, and image editing features as claimed in claim 16 comprises the steps of:
adding the photograph selection to the image library of the customer account;
adding the photograph selection to a marketplace listing, wherein the photograph selection can be bought through the marketplace listing;
receiving a photograph payment for the photograph selection from a secondary account; and
sending the photograph payment to the customer account.
